(19) United States
(12) Patent Application Publication
(10) Pub. No.: US 2006/0023292 A1
(43) Pub. Date: Feb. 2, 2006

(54) Method of making dynamic image for an article and article thereof

(76) Inventor: Joseph S. Simone JR., Gibbsboro, NJ (US)

Correspondence Address: BLANK ROME LLP, 600 NEW HAMPSHIRE AVENUE, N.W., WASHINGTON, DC, 20037, US

(21) Appl. No.: 11/189,790

(22) Filed: Jul. 27, 2005

Related U.S. Application Data
(60) Provisional application No. 60/592,343, filed on Jul. 28, 2004.

(51) Int. Cl. G02F 1/01

(52) U.S. Cl. 359/288; 156/83

(57) ABSTRACT

A method for making a dynamic graphic for application to an article, comprising the steps of selecting a graphic, separating the graphic into a constant image and a latent image, the constant and latent images being subject matter related, the constant image having at least one color, and the latent image having at least one color, preparing a first screen for the at least one color of the constant image, the first screen including a non-color changing ink, and preparing a second screen for the at least one color of the latent image, the second screen including a color changing ink that changes upon exposure to an activator. The method also includes applying the first screen to the article, thereby registering the at least one color of the constant image on the article with the constant image always being visible on the article, and applying the second screen to the article, thereby registering the at least one color of the latent image on the article, and the latent image only being visible when the article is exposed to the activator.

### RELATED APPLICATION

This application claims the benefit of U.S. Provisional Application Ser. No. 60/592,343 entitled Color Changing Graphic Design filed on Jul. 28, 2004.

### FIELD OF THE INVENTION

The present invention relates to the method of making and displaying a dynamic graphic on an article. More specifically, the graphic of the article changes upon exposure to an activator, such as ultraviolet light.

### BACKGROUND OF THE INVENTION

Conventionally, when silk-screening an article, a piece of sheer fabric, typically silk, polyester, or similar fabric, plastic or mesh, is stretched over a frame made of wood, plastic, aluminum or any other suitable material. This piece of fabric is the “screen.” A thin sheet of plastic containing holes corresponding to the selected graphic to be silk-screened is then placed over the fabric. Next, the article is placed on a flat board and the screen is pressed onto the fabric. The screen is then coated with ink by a sponge, and the ink flows through the screen and holes of the thin sheet of plastic onto the article. For multi-colored designs or graphics, this step is performed several times, beginning with the lightest color and progressing to the darkest color. Most articles containing silk-screened graphics have images that do not move or change.

Photochromic textile screen inks have been used for silk-screening articles. Photochromic inks are plastisol inks that gain color when exposed to ultraviolet (UV) light. The color change is reversible, i.e. the color fades upon removal from UV exposure. The photochromic inks come in various but limited colors. As such, designs or graphics are limited to only those colors. Also, even when not exposed to UV light, the photochromic inks are off-white or yellow and therefore still visible on the article.

Photochromic inks produce one image when not exposed to UV light that generally appears to lack color, that is it is off-white or yellow, and another image when exposed to UV light that appears in color. However, the outline of the image when not exposed to UV light typically can be viewed because of its off-white or yellowish color, that is, it is not latent.

Examples of conventional color changing displays include U.S. Patent Application Publication Nos. 2004/0135097 to Shibahashi et al. and 2004/0237164 to Aperfine et al., and U.S. Pat. No. 5,985,381 to Conner, U.S. Pat. No. 5,383,959 to Sirdesai et al., U.S. Pat. No. 5,282,651 to Alonso, U.S. Pat. No. 5,202,677 to Parker et al., U.S. Pat. No. 4,838,965 to Bussard, U.S. Pat. No. 4,142,782 to O'Brian, U.S. Pat. No. 4,032,687 to Hornsby, Jr., the subject matter of each of which is incorporated by reference.

### SUMMARY OF THE INVENTION

Accordingly, an object of the present invention is a method of making a dynamic graphic that includes a latent image that corresponds with a permanent image to create a dynamic graphic display.

Another object of the present invention is a method of making a dynamic graphic that includes a latent image not visible when not exposed to an activator.

Yet another object of the present invention is to provide an article with a dynamic graphic thereon.

The foregoing objects are attained by a method for making a dynamic graphic for application to an article, comprising the steps of selecting a graphic, separating the graphic into a constant image and a latent image, the constant and latent images being subject matter related, the constant image having at least one color, and the latent image having at least one color, preparing a first screen for the at least one color of the constant image, the first screen including a non-color changing ink, and preparing a second screen for the at least one color of the latent image, the second screen including a color changing ink that changes upon exposure to an activator. The method also includes applying the first screen to the article, thereby registering the at least one color of the constant image on the article with the constant image always being visible on the article, and applying the second screen to the article, thereby registering the at least one color of the latent image on the article, and the latent image only being visible when the article is exposed to the activator.

The forgoing objects are also attained by a method for making a dynamic graphic for application to an article, including the steps of selecting a graphic, separating the graphic into a constant image and a latent image, the constant and latent images being subject matter related, the constant image having a plurality of colors, and the latent image having a plurality of colors, preparing a first screen for each of the colors of the constant image, each of the first screens including a non-color changing ink, and preparing a second screen for each of the colors of the latent image, each of the second screens including a photochromic ink that changes upon exposure to ultraviolet light. The method also includes the steps of applying the first screens to the article, thereby registering the colors of the constant image on the article with the constant image always being visible on the article, and applying the second screens to the article, thereby registering the colors of the latent image on the article, and the latent image only being visible when the article is exposed to ultraviolet light.

Other objects, advantages and salient features of the invention will become apparent from the following detailed description, which, when taken in conjunction with the annexed drawings, discloses preferred embodiments of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front elevational view of an article displaying a dynamic graphic in accordance with the present invention, the display showing the graphic when not exposed to an activator;

FIG. 2 is a front elevational view of the article similar to FIG. 1, showing both the graphic when exposed to the activator; and

FIG. 3 is a flow chart of the method of making a dynamic graphic in accordance with the present invention.

### DETAILED DESCRIPTION OF THE INVENTION

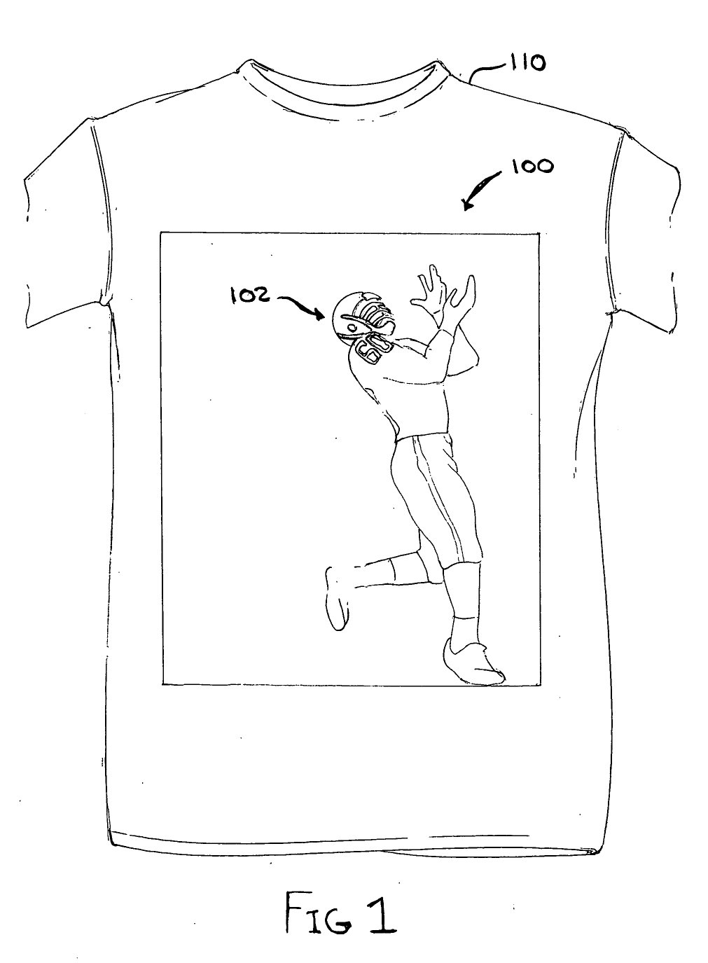

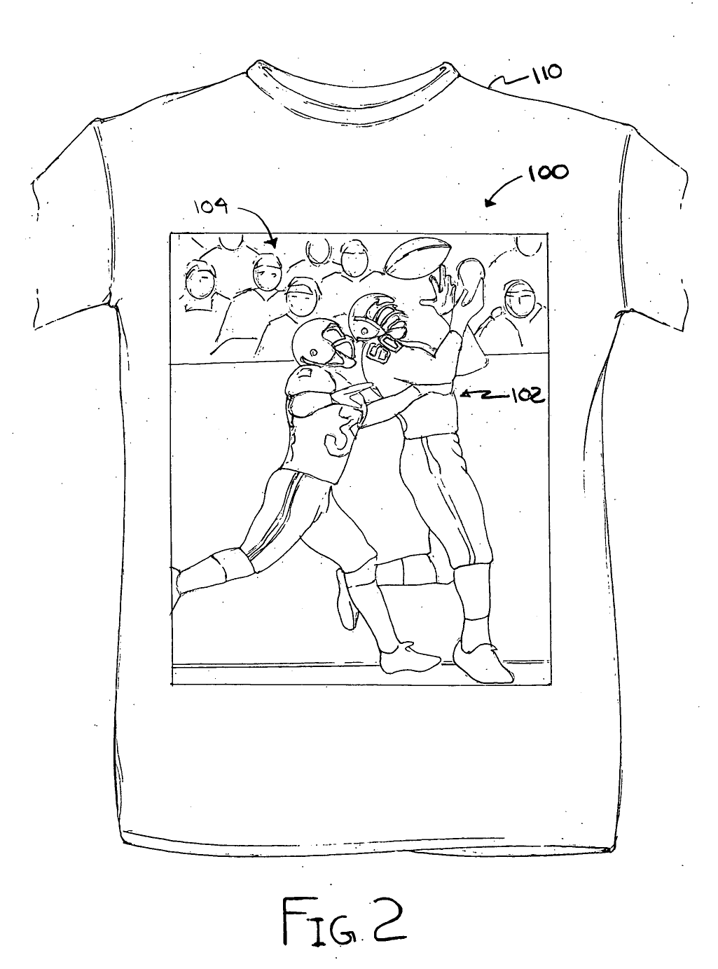

Referring to FIGS. 1-3, the method of making a dynamic graphic 100 for display on an article 110 in accordance with the present invention generally includes the steps of selecting a graphic 100, forming a constant image 102 of the graphic using non-color changing inks and a latent image 104 of the graphic using color changing inks that change color when activated (FIG. 2). Application of the constant and latent images 102 and 104 on the article 110 provides a dynamic display of the graphic 100 for the article 110 when exposed to the activator, such as heat or ultraviolet light. Although article 110 is shown as a T-shirt, the article 110 can be any item having a surface that can display a graphic including but not limited to a piece of apparel, a piece of kitchenware, such as a mug, an accessory, such as a key chain or wallet, an advertisement, such as a billboard, poster, or banner, an architectural structure, a collector item, a piece of memorabilia, or combinations thereof. The graphic can be any type of indicia including designs, artwork, logos, text, and the like.

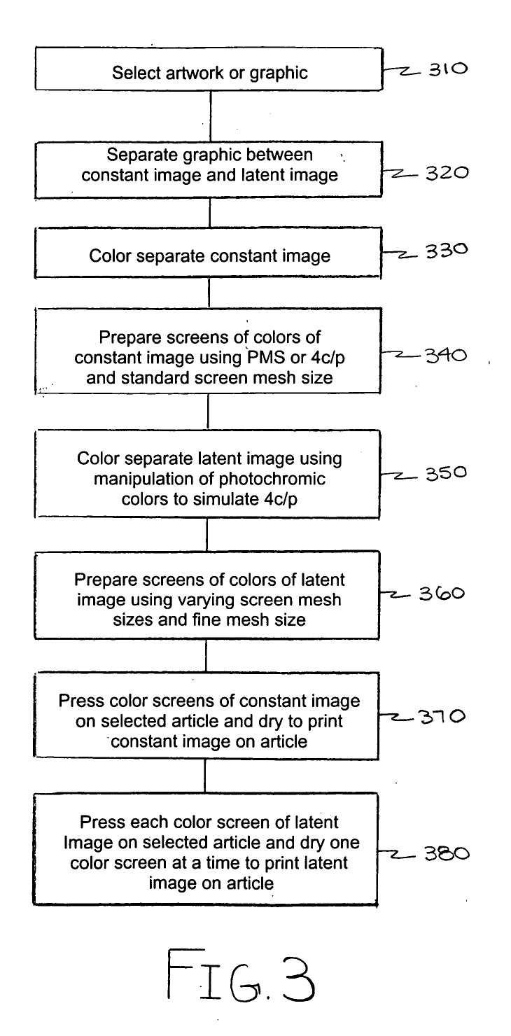

Referring to FIG. 3, a piece of artwork or a graphic is first selected at step 310. After a design or graphic is selected, the graphic is separated at step 320 between the constant or permanent image 102 to be applied using non-color changing ink and the latent image 104 to be applied using color changing ink that will appear upon exposure to an activator. The latent image 104 is shown only in FIG. 4 because the latent image 104 is not visible when not exposed to an activator, as seen FIG. 2, in which only the constant image 102 is visible. Preferably, photochromic inks are used for the latent image 104, however, any color changing ink can be used, such as thermochromic ink, glow-in-the-dark ink, hydrochromic ink, piezochromic ink, or combinations thereof. Photochromic inks are preferred because of their unlimited and widening varieties of graphic conditions. They are less limited to the variables need to create the ancillary condition. Since UV rays can be both naturally and artificially created, the effect of the graphic can be displayed regardless of season or time of day and not limited to temperature conditions. This allows applications for operation in venues both indoors and outdoors, such as for entertainment like sports or concerts, or for advertisements.

The constant image 102 is then color separated at step 330. A screen is prepared for each color at step 340 using any known method in the graphics arts, such as the four color process (CMYK), cyan, magenta, yellow and black, the pantone matching system (PMS), a preprint discharge ink system, or the like. CMYK is a color model in which all colors are described as a mixture of the four process colors, that is cyan, magenta, yellow and black. CMYK is the standard color model used in offset printing for full-color documents. PMS is a color matching system used by the printing industry to print spot colors. Most applications that support color printing allow you to specify colors by indicating the Pantone name or number. PMS works well for spot colors. If multiple colors are present in the image, then multiple screens are prepared. The preprint discharge ink system can be used to apply the constant image to the article 110, particularly if the article is colored, such as a colored T-shirt. In particular, the preprint discharge ink system includes applying water-based inks to the colored article or garment to produce very bright, soft prints. As the discharge inks are printed and heat cured, the original dyes on the garment are reduced or discharged from the graphic area and the printed image is bonded to the fabric. The result is a brightly colored, opaque image which has been applied directly to a virtually undyed area of the garment and the garment remains soft. Also, the size of each screen is limited to the total number of screens and blanking stations available on the silk-screen equipment. A standard mesh size can be used for each screen. For example, a mesh size of 300, i.e. number of openings per linear inch, can be used for each screen of the colors of the constant image 102.

Each screen is coated with a light-sensitive emulsion and is exposed to a powerful light source, such as UV light, which passes first through the film and then through the screen emulsion. The UV in the light source changes the emulsion from water-soluble to water-resistant. The part of each screen blocked by the image on the film remains water-soluble because it is not exposed to the light. Next, the exposed screen is sprayed with water and the image area washes out. Each screen is dried and the edges are taped off. The image appears on each screen as a stencil and each screen is ready to be applied to the article.

At step 350, the latent image 104 is also color separated. Because photochromic inks are available in limited colors and are not available in cyan, magenta, yellow or black, a simulated four color process is used to prepare each screen at step 350. This simulated process provides a more precise color match with the selected graphic 100 than could be achieved using the standard colors available for photochromic inks. The simulated process involved manipulation of the standard colors of photochromic inks to create the specific colors of the latent image 104. More specifically, the standard colors of photochromic inks are mixed with colors being added or subtracted until the desired color is obtained. Computer software, such as Adobe's PHOTOSHOP software, can be used to assist in this process by using the color palate of the standard colors of photochromic inks and mixing and manipulating the colors to obtain the specific colors of the latent image.

Once the appropriate colors of the latent image 104 are determined using the simulated four color process and separated, screens for each color are prepared at step 360 in a manner similar to the colors of the constant image 102. The screens for the color changing inks of the latent image 104 are generally coarser or larger than the mesh sizes of the screens of the colors of the non-color changing inks of the constant image 102. Also, it is preferred that the screens for the color changing inks have a finer or smaller mesh size than that of the standard screen mesh size currently used for color changing inks. More specifically, the screen mesh size of the color changing inks for latent image 104 are between 111-210, and preferably 150-200 compared to the conventional screen mesh size of 110 or less for standard color changing inks. Because the mesh size of the screens for the colors of the latent image 104 are finer than the mesh size of standard screens, a lighter and thinner application of photochromic inks is achieved such that inks are invisible when applied to the article, thereby eliminating the off-white or yellow cast.

In addition, each color of the latent image 104 may require a different screen mesh size to more precisely reproduce the graphic on the article. The size of the mesh of the screen is dictated by the amount of color desired. For example, a navy colored ink can be applied as a light blue color by using a very fine mesh size. Thus the screen mesh sizes of the color changing inks of the latent image 104 are dictated by the desired colors for the graphic.

At steps 370 and 380, the screens of the constant and latent images 102 and 104 are printed on an article to display the dynamic graphic 100. To print a screen, the press operator mounts a screen into a press, which can be either a manual or automatic press. The manual press utilizes human hands for pulling a squeegee type object, or the like, while the automatic press utilizes machinery. The squeegee type object pushes ink through the holes of the screen and ink appears on the article. This process repeats itself with each screen, until all colors are applied to the article.

Preferably, the first colors to be printed are the non-color changing inks of the constant image 102. After all of the ink has been applied to the article, the ink needs to be dried or cured. To dry the ink, the article is placed on a dryer belt which carries the article through a dryer, which is preferably a gas-fired dryer although any type of dryer is sufficient. The dryer is set to a temperature between approximately 300° F. and approximately 350° F. The dryer heats the article for between approximately 20 seconds to approximately 90 seconds.

After the non-color changing ink is cured, the color changing ink is applied to the article using the steps set forth above. However, each color changing ink color is dried before the next color changing ink color is applied. Allowing each color changing ink color to dry before additional color changing ink colors are applied results in the color changing ink being latent until activated. Because the color changing ink is not visible without an activator, an artificial light must be used particularly for photochromic inks to ensure proper registration of the latent image 104 with the constant image 102 on the article. The ink is preferably passed over the screen at least twice. To completely cure the color changing ink, the article is heated for approximately 30 to approximately 90 seconds in a gas-fired dryer set to a temperature between approximately 310 F and approximately 320 F. This drying step allows the article to be wet and/or washed without the ink cracking or peeling off. Allowing each color changing ink color to dry before additional color changing ink colors are applied results in the color changing ink being latent until activated.

After the article is silk-screened as described above, when the article is exposed to an activator, such as UV light, the dynamic graphic 100 changes. For example, as seen in FIG. 1, the constant image 102 not exposed to an activator could be a leaping football player with outstretched arms. When exposed to the activator, the latent image 104 of the spectator filled stadium, the football, and a defensive player appears, as seen in FIG. 2. The constant and latent images are related in subject matter to develop a story that is being told through the dynamic graphic 100 on the article. The constant image 102 shows the football player trying to make a catch but does not reveal what is taking place around or near the player. When the article is exposed to the activator, the rest of the story is revealed, that is the play of the football game and the surrounding stadium is revealed. Another example of a dynamic graphic 100 is a poem or song where the constant image 102 is the first part of the poem or song and the latent image 104 is the second part of the poem or song.

Different type of color changing inks can be combined to print an image on an article. By using inks which appear or disappear as functions not only of light, but in reaction to heat, water, etc., the story-telling force of the article to which the ink is applied is enhanced. For example, a single graphical image composed of more than two type of color changing ink are applied and which appear or disappear as a function of their two difference activators, will have multiple different and dynamically changeable visual presentations from the same article. In the case of photochromic and thermochromic inks combined in a single image, there would be as many as seven constant and different visual effects displayed by the same article, i.e. the basic visual effect when worn indoors or in the evening; a second visual effect when worn in sunlight; a third visual effect when worn in both sunlight and heat; a fourth visual effect when worn in the presence of heat and no sunlight; a fifth visual effect when worn wet and in sunlight, e.g. swimming in a pool; a sixth visual effect when worn wet and in sunlight combined with heat; and a seventh visual effect when worn in the presence of artificial darkness, e.g. indoors at a nightclub.

Although silk screening is the preferred manner in which to apply the dynamic graphic 100 to the article 110, other graphic design application techniques, including, but not limited to offset lithography, flexography, gravure, air brush, and hand painting can be used. These techniques can be used either individually or in combination with one another.

While particular embodiments have been chosen to illustrate the invention, it will be understood by those skilled in the art that various changes and modifications can be made therein without departing from the scope of the invention as defined in the appended claims. For example, the color changing ink can be applied to the article so that a portion of or the entire article itself changes color when exposed to the activator. Another example is that the article, such as a piece of apparel, can project two different images so as to effect two or more different versions of the apparel from the same article. More specifically, the apparel can be more formal black and white in the evening versus multi-colored during the day.

What is claimed is:

1. A method for making a dynamic graphic for application to an article, comprising the steps of:
selecting a graphic;
separating the graphic into a constant image and a latent image, the constant and latent images being subject matter related, the constant image having at least one color, and the latent image having at least one color;
preparing a first screen for the at least one color of the constant image, the first screen including a non-color changing ink;
preparing a second screen for the at least one color of the latent image, the second screen including a color changing ink that changes upon exposure to an activator;
applying the first screen to the article, thereby registering the at least one color of the constant image on the article with the constant image always being visible on the article; and
applying the second screen to the article, thereby registering the at least one color of the latent image on the article, and the latent image only being visible when the article is exposed to the activator.

2. The method according to claim 1, wherein
the color changing ink is a photochromic ink.

3. The method according to claim 1, wherein
the color changing ink is selected from the group consisting of thermochromic ink, glow-in-the-dark ink, hydrochromic ink, piezochromic ink and combinations thereof.

4. The method according to claim 1, wherein
a mesh size of the second screen is different than the mesh size of the first screen.

5. The method according to claim 4, wherein
the mesh size of the second screen is coarser than the mesh size of the first screen.

6. The method according to claim 1, further comprising the steps of:
preparing a plurality of first screens for each of a plurality of colors of the constant image, the plurality of screens for the colors of the constant image including different non-color changing inks; and
preparing a plurality of second screens for each of a plurality of colors of the latent image, the plurality of screens for the colors of the latent image including different color changing inks that change upon exposure to an activator.

7. The method according to claim 6, further comprising the steps of:
applying the plurality of first and second screens to the article to register the plurality of colors of the constant and latent images on the article.

8. The method according to claim 7, wherein
the color changing inks are photochromic inks.

9. The method according to claim 7, wherein
the plurality of second screens have different mesh sizes.

10. The method according to claim 7, wherein
the plurality of second screens each have a mesh size substantially coarser than a mesh size of each of the first screens.

11. The method according to claim 7, wherein
the mesh sizes of the plurality of second screens range between 150-200 openings per inch.

12. The method according to claim 1, further comprising the step of
drying the non-color changing ink of the constant image on the article; and
drying the color changing ink of the latent image on the article.

13. The method according to claim 1, further comprising the step of:
selecting the article from the group consisting of a piece of apparel, a piece of kitchenware, an advertisement, an accessory, a vehicle, an architectural structure, a piece of memorabilia, a collector item, and combinations thereof.

14. The method according to claim 1, wherein
the first and second screen are applied to the article by silk screening.

15. A method for making a dynamic graphic for application to an article, comprising the steps of:
selecting a graphic;
separating the graphic into a constant image and a latent image, the constant and latent images being subject matter related, the constant image having a plurality of colors, and the latent image having a plurality of colors;
preparing a first screen for each of the colors of the constant image, each of the first screens including a non-color changing ink;
preparing a second screen for each of the colors of the latent image, each of the second screens including a photochromic ink that changes upon exposure to ultraviolet light;
applying the first screens to the article, thereby registering the colors of the constant image on the article with the constant image always being visible on the article; and
applying the second screens to the article, thereby registering the colors of the latent image on the article, and the latent image only being visible when the article is exposed to ultraviolet light.

16. The method according to claim 15, further comprising the step of:
drying all of the non-color changing inks of the first screens after application to the article.

17. The method according to claim 15, further comprising the step of:
drying the photochromic ink of each of the second screens after application of each of the second screens to the article before applying the next second screen.

18. The method according to claim 15, wherein
each of the second screens has a mesh size, and the mesh sizes of the second screens are different than one another.

19. The method according to claim 18, wherein
the mesh sizes of the second screens range between 150-200 openings per inch.

20. The method according to claim 15, wherein
each of the first screens has a mesh size; and
each of the second screens has a mesh size, the mesh sizes of the second screens are coarser than the mesh sizes of the first screens.

21. The method according to claim 15, further comprising the step of
prior to preparing the second screens, determining each color of the latent image by mixing photochromic inks to create a color match to each color of the latent image of the selected graphic.

22. The method according to claim 15, further comprising the step of:
selecting the article from the group consisting of a piece of apparel, a piece of kitchenware, an advertisement, an accessory, a vehicle, an architectural structure, a piece of memorabilia, a collector item, and combinations thereof.

23. The method according to claim 15, further comprising the step of:
preparing a third screen for one of the colors of the latent image, the third screen including color changing ink selected from the group consisting of thermochromic ink, glow-in-the-dark ink, hydrochromic ink, piezochromic ink and combinations thereof.

24. An article for displaying a dynamic graphic, comprising:
a surface, said dynamic graphic being disposed on said surface,
said dynamic graphic including a constant image and a latent image, the subject matter of the constant and latent images being related to one another,
said constant image including a plurality of colors each formed by a non-color changing ink, and said latent image including a plurality of colors each formed by a photochromic ink,
said constant image always being visible and said latent image being visible when exposed to ultraviolet light and invisible when not exposed to ultraviolet light.

25. An article according to claim 24, wherein
said latent image includes at least one color formed by color changing ink selected from the group consisting of thermochromic ink, glow-in-the-dark ink, hydrochromic ink, piezochromic ink and combinations thereof.
